(19) United States
(12) Patent Application Publication
(10) Pub. No.: US 2025/0303292 A1
(43) Pub. Date: Oct. 2, 2025

(54) Generative Outputs Confirming to User's Own Gameplay to Assist User

(71) Applicant: Sony Interactive Entertainment LLC, San Mateo, CA (US)

(72) Inventor: Sean Whitcomb, San Mateo, CA (US)

(21) Appl. No.: 18/623,818

(22) Filed: Apr. 1, 2024

(51) Int. Cl. A63F 13/5375; A63F 13/25

(52) U.S. Cl. CPC A63F 13/5375; A63F 13/25

(57) ABSTRACT

Generative models are disclosed to generate audio and visual outputs to a user when the user struggles with a particular aspect of a video game. The generative outputs can demonstrate what success at that aspect of the game looks like, doing so using the same playstyle, ability, and tactics as the user themselves to provide relevant and feasible assistance to the user.

### FIELD

The present application relates generally to generative outputs for video games to assist users according to each user's own gameplay.

### BACKGROUND

As recognized herein, video games sometimes have help features. However, those help features are static and technically inadequate. As a consequence, they only provide limited game assistance. Present principles recognize that much is left to be desired.

### SUMMARY

Accordingly, in one aspect an apparatus includes at least one processor system configured to determine to provide game assistance to a first player to help the first player play a particular aspect of a video game. The at least one processor system is also configured to access data related to a cluster of previous gameplay instances that also relate to the same particular aspect of the video game. Based on the determination, the at least one processor system is configured to execute a generative model to provide an output to the player related to playing the particular aspect of the video game, with the output being generated based on the data related to the cluster of previous gameplay instances that also relate to the same particular aspect of the video game.

In some embodiments, the data may include past videos of previous gameplay instances that also relate to the same particular aspect of the video game. In one example according to these embodiments, the output may include a first video that is generated by the generative model based on the past videos of previous gameplay instances, with the first video showing the first player how to play the particular aspect of the video game using a play style and/or play tactic associated with both the first player and the past videos. Also in an example according to these embodiments, the output may include audio output instructing the first player how to play the particular aspect of the video game using a play style and/or play tactic associated with both the first player and the past videos. Also according to these embodiments, the output may include an alphanumeric text output instructing the first player how to play the particular aspect of the video game using a play style and/or play tactic associated with both the first player and the past videos. These examples may be combined together or executed separately in various implementations.

Additionally, if desired in some example embodiments the at least one processor system may be configured to make the determination using a first pattern recognition model and to associate the previous gameplay instances with each other using a second pattern recognition model different from the first pattern recognition model.

In some examples, the output may be tailored to a gameplay ability level identified for the first player. The at least one processor system may be configured to present a prompt to the first player that the output is available based on the determination, and/or to provide the output itself responsive to a request from the first player for assistance. The request from the first player for assistance may include an audible request in certain specific examples.

Additionally or alternatively, the output may indicate a same sequence of game moves that have been identified as being performed by the first player while playing the particular aspect of the video game. Also in various examples, the particular aspect of the video game may relate to a boss battle and/or may relate to navigating a particular area of a virtual world of the video game.

In another aspect, a method includes determining to provide game assistance to a first player to help the first player play a particular aspect of a video game. The method also includes accessing data related to previous gameplay instances that also relate to the particular aspect of the video game. Based on the determination, the method includes executing a generative model to provide an output to the player related to playing the particular aspect of the video game, where the output is generated based on the data related to previous gameplay instances that also relate to the particular aspect of the video game.

In various examples, the method may include one or more of identifying the previous gameplay instances based on the previous gameplay instances being associated with other players of a similar skill level as the first player, identifying the previous gameplay instances based on the previous gameplay instances using a same game move that the first player has been identified as using to play the particular aspect of the video game, and/or identifying the previous gameplay instances based on the previous gameplay instances using a same playstyle as the first player has been identified as using to play the particular aspect of the video game.

In still another aspect, an apparatus includes at least one computer medium that is not a transitory signal. The at least one computer medium includes instructions executable by at least one processor system to determine to provide game assistance to a first player to help the first player play a particular aspect of a video game. Based on the determination, the instructions are executable to execute a model to provide an output to the player related to playing the particular aspect of the video game, with the output being generated based on video game data for previous gameplay instances that relate to success at the particular aspect of the video game.

In certain example implementations, the model may include a pattern recognition model and/or a generative model.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 illustrates a video game situation consistent with present principles in which a user is struggling with a certain aspect of a video game and is prompted that generative assistance is available;

FIG. 3 demonstrates example generative assistance consistent with present principles that may be audibly and visually presented to the user;

FIG. 4 illustrates example artificial intelligence (AI) architecture that may be used consistent with present principles;

FIG. 5 illustrates example overall logic in example flow chart format that may be executed by a device/gaming system consistent with present principles;

FIG. 6 illustrates an example settings graphical user interface (GUI) that may be presented to a user to opt-in to various aspects of present principles; and

FIG. 7 illustrates example network architecture that may be used consistent with present principles.

### DETAILED DESCRIPTION

Among other things, disclosed below are devices and methods for providing generative outputs to a user to demonstrate what success looks like when playing a particular aspect of a video game with which the user is struggling. Not only that, but the generative output of what success looks like may be conformed to the user's playstyle, play tactics, and/or ability level so that the user is provided with outputs that are feasible for the user themselves to accomplish regardless of how advanced or novice the user might be. In this way, an AI-generated personalized coaching report may be generated for each player.

Present principles may be used in a variety of different game types, from first person shooter games to e-sports games to role playing games and still others. Present principles may be used in single-player game instances as well as multi-player game instances, whether executed by a local console and/or a cloud streaming platform alone or in any appropriate combination.

So as an example, if the user cannot beat a boss or cannot advance past a certain point in the game, but the user would still like to get better and doesn't understand why they cannot advance past that point in the game, the user may request a generative output to demonstrate to the user how to progress past that point in the game (e.g., the user may provide an audible request through a microphone that is being actively used for listening for user commands). To produce the generative output, a stored history of past gameplay instances may be accessed, where that history may include a spectrum of different gamers who've done what the player wants to do but in the past. Some of those different gamers may have done the same thing successfully using similar tactics, playstyle, and ability as the user themselves, while other gamers in the history may have done so using other tactics, playstyles, and/or ability levels. Different artificial intelligence (AI) models may then be used as set forth in greater detail below to sort through the videos in the history and use similar videos to model a new, generative video that shows the user's own game character performing a successful game action just as the user might do themselves.

As a specific example, suppose the system determines that the user has been playing a certain level or other aspect of a game for at least a threshold amount of time while using a given playstyle, like trying to advance up various vertically-oriented platforms using a same cadence. Also suppose the system identifies the user as typically trying to advance from a lower platform to an upper right platform but never to an upper left platform. Based on this, the system may search for other players that have played that part of the game the same way but successfully, and then generate a generative video for the user using the past videos of those other players. The generative video may be delivered to the user direct within the console manufacturer's network and platform without the user having to leave the game environment (e.g., without exiting the game). The generative video itself may in a way act as an amalgamation of all players who have defeated/successfully completed that specific challenge in the same way the user is attempting, showcasing what success looks like, but through a generative output tailored to that user's specs rather than through videos of actual real-life gameplay.

Then if the user struggles again in a subsequent, different aspect of the game, another cluster of past videos from the history may be used to provide a generative output for that other portion of the game. In this way, the cluster of representative success videos that are used to generate a new video for the user may change over time depending on game state, game level, game location, and even evolving player ability and tactics.

What's more, note that in addition to or in lieu of generative video, other generative outputs may also be provided to the user, such as generative text and/or generative audio output. If desired, these other outputs (and even the generative video itself) might be provided as part of an accessibility feature to help users of all types. A generative text output might be a mere sentence or two to help the user, or may be more robust. Similarly, generative audio output may be a mere sentence or two or may be more robust. In this way, successful gameplay according to the user's own abilities may be summarized down into a few sentences, or may be more detailed. For quick generative audio summaries of game moves to complete, this might be advantageous where the user only needs to know the gist of the generative video that gets generated and might not even elect to watch the generative video itself, instead receiving the audio help within whatever short window of time the user might have to make a decision and take a game action. But in other instances, a lengthier audio summary and accompanying generative video may be observed by the user if the game action is complex or the user just needs the extra help if they are really struggling.

As an example of a shorter output that might have a limited time window of relevancy, suppose that rather than being unable to advance past a boss or get around a certain obstacle within the game, the user's character walks past a hidden treasure multiple times in the game world without the user noticing it. Here the system may determine that a generative video may not be best as the resulting video would be longer than the window of time the user has to find and select the hidden treasure before being out of range again, and so instead the system may present a short audio clip like “look left” to cue the user to look left in the game world and potentially discover the hidden treasure.

Prior to delving further into the details of the instant techniques, note that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

The term “a” or “an” in reference to an entity refers to one or more of that entity. As such, the terms “a” or “an”, “one or more”, and “at least one” can be used interchangeably herein.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

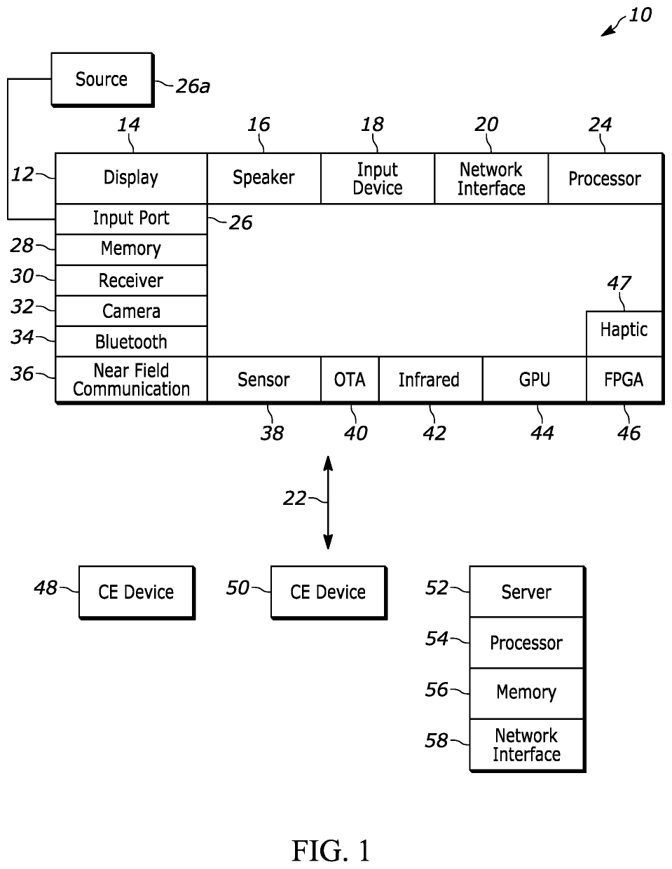

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors/processor system 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a specific type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, some models herein may be implemented by classifiers in particular.

As understood herein, performing machine learning may involve accessing and then training a model on training data to enable the model to process further data to make inferences. For example, back propagation may be used during training to change the weights of the model. An artificial neural network/artificial intelligence model trained through machine learning may thus include an input layer, an output layer, and multiple hidden layers in between that are configured and weighted to make inferences about an appropriate output.

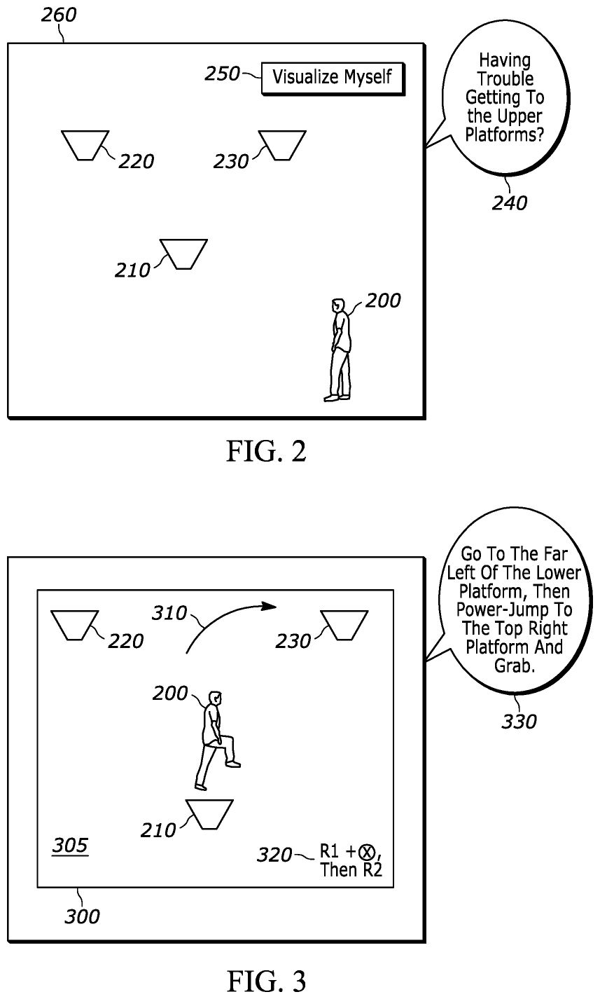

Now in reference to FIG. 2, suppose an end-user is playing a video/computer game in which, as part of reaching a boss to battle at the end of a given game level, the user's character 200 has to navigate a particular area of the virtual world of the video game. In this case, this navigation includes advancing upwards in the virtual world by jumping progressively upward on platforms 210-230. Also assume the user is having difficulty navigating the character 200 up to the upper platforms 220, 230 themselves.

Using present principles, game state data and other game engine data (like game video) may be fed into a first, discriminative artificial intelligence-based model trained for detecting that video game users are struggling with a particular aspect of a game and that game assistance may thus be appropriate. Various types of pattern recognition AI models may therefore be used for the first AI-based model, including recurrent neural networks and feed-forward neural networks. Different particular pattern recognition algorithms may also be used, including different classification, clustering, and regression algorithms. The first AI-based model may even be trained on datasets particularly relating to the same game being played by the particular user in this instance, if desired.

Thus, the game engine may, upon receipt of output from the first AI-based model, determine that the user should be provided with game assistance since the user is currently struggling to advance up the platforms 210-230. In response to the determination, FIG. 2 shows that an audible prompt 240 may be presented via one or more connected speakers. As shown, the prompt 240 may audibly ask the user if the user is having trouble with the particular aspect of the video game and/or whether the user would like assistance. Also in response to the determination, a prompt in the form of a selector 250 may be overlaid on the user's game field of view 260 as also shown in FIG. 2. Haptic output may also be provided as a prompt, such as vibrating a video game controller being used by the user to signify that generative assistance is available.

While awaiting user input in response to the prompt(s), or at another time such as before presenting the audio prompt 240 and selector 250 themselves, the system may also execute second and third discriminative models, both of which may be pattern recognition models trained to provide different types of outputs. The second model may be trained to recognize the user's playstyle and tactics as well as the user's overall skill/ability level. Game state data, user inputs to a video game controller, audio inputs from the user, and other types of data may thus be fed into the second model to get an output of overall skill/ability level as well as particular playstyle(s) and/or play tactics used (e.g., particular controller button combinations used, particular sequence of moves used, particular types of directional character movement performed, etc.).

The playstyle, tactic, and/or ability level data may then be fed into the third model as input. The third model may then be used to identify a cluster of previous gameplay instances for players other than the user themselves but that also relate to the same particular aspect of the video game, with those previous gameplay instances being instances in which the respective past player's action(s) resulted in success in beating, progressing past, or otherwise being successful at the same particular aspect of the game with which the user themselves is currently struggling. The third artificial intelligence-based model may thus be trained for pattern recognition to cluster similar videos together based on one or more criteria (e.g., particular playstyles, tactics, and/or ability level).

Still in reference to FIG. 2, the user may respond to the prompt(s) that are presented various ways. For example, the user may respond audibly in the affirmative to the prompt 240 as detected by a system microphone. The user may also control their video game controller or provide voice input selecting the selector 250 to also provide a command for the system to provide game assistance. In response to the audible input or input to selector 250, FIG. 3 demonstrates that the system may then provide audible output 330 as well as visual output 300, both of which may have been generated using a fourth, generative model.

One or more text-to-video models may be used as part of the generative model. Those models may include pre-trained transformer models, video diffusion models such as full latent diffusion models and other types of diffusion models, and/or an encoder-decoder model and a transformer model in combination. Generative adversarial networks (GANs) such as Deep Convolutional Generative Adversarial Networks (DCGANs) may also be used, as well as still other generative video models.

Natural language processing (NLP) algorithms as well as large language models (LLMs) may also be included in the generative model. The NLP algorithm(s) and/or LLM(s) may thus be executed to gain context and other information from the game engine data to then generate a natural language description of the user's trouble with that particular aspect of the game. The natural language description may also indicate (per the game engine data) other context related to the user's game instance/struggles, including what is occurring in the game itself at the point of the user's struggles, what game level the user is at, what boss/adversary is currently being battled, what user playstyle and play tactics are being used, the user's ability level, what the characteristics are of the user's game character (such as character name and current character skins/appearance), etc.

The NLP/LLM may also be configured to output additional text in natural language that requests a generative video of success at the same particular aspect of the game according to the other aspects of the natural language text generated per the description above. All of the resulting text from the NLP/LLM, and the identified cluster of similar videos output by the third model, may then be fed into the text-to-video portion of the generative model as input. In response, the text-to-video model(s) may then generate a new video of the user's character 200 playing in the user's play style and/or with the user's particular playing tactics (e.g., speed, input/button sequence combinations, etc.) according to the natural language description that is provided, with the generative video conforming to the description from the natural language input but showing the user's character succeeding at whatever the user themselves cannot accomplish in the game.

The generative (synthetic) video showing the character 200 playing according to the user's playstyle and tactics (but not generated based on actual game inputs from the user themselves) may then be presented to the user as shown in FIG. 3. As shown, an overlay graphical user interface (GUI) 300 may be presented on the user's display over top of the user's game field of view. The overlay GUI 300 may therefore include a generative video 305 of the character 200 advancing up the platform(s) 210-230, and may even include additional non-game-specific graphics such as an arrow 310 showing the user a direction in which to control the character 200 to advance up the platforms 210-230.

The output from the generative model may also include alphanumeric text and controller button graphics 320 instructing the user how to play the particular aspect of the video game using a play style and/or play tactic identified as associated with the user. In the present instance, the text/graphics 320 include text instructing the user to press the R1 button on the video game controller and to concurrently press the “X” button (shown as a graphic for the “X” button), with the text further instructing the user to subsequently press the “R2” button to perform another game move to advance within the game according to this sequence.

FIG. 3 also shows that, if desired, generative audio 330 may accompany the generative video 305 and text/graphics 320. The generative audio 330 may be output using one or more connected speakers while the video 305 is playing out in real time. The generative audio 330 may be audio produced by the generative model with the video 305 itself (e.g., as part of the video 305) and, as such, may include in-game sounds that would otherwise be output by the game engine based on user inputs and current game state. Those in-game sounds might therefore include jump sounds or other in-game action sounds, game background music, audio of game characters speaking, etc.

Additionally or alternatively, the generative audio 330 may narrate what is occurring in the generative video 305 to further aid the user, may read aloud the generative text/graphics 320, and/or may provide additional commands and instruction beyond what is already shown on the overlay 300. For instance, the audio 330 may indicate character movement commands beyond what is specified in the output 320, such as for the user to control the character 200 to go to the far left of platform 210 and, from that position, power-jump to the top right platform 230 and then perform a grab action to grab the platform 230 and climb up on it.

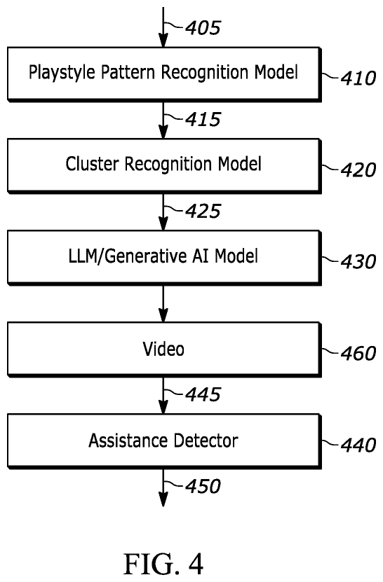

FIG. 4 shows example artificial intelligence (AI) model architecture 400 that may be used consistent with present principles. As shown, an assistance detector 440 may be used to initially detect that a user could use assistance in a particular aspect of a video game. The detector 440 may therefore be established in certain examples by the first discriminative model for pattern recognition mentioned in the example of FIG. 2 above. The detector 440 may thus be established by a recurrent neural network and/or a feed-forward neural network. The detector 440 may employ various pattern recognition algorithms, including classification, clustering, and/or regression algorithms. For clustering algorithms in particular, examples that may be used include density-based, distribution-based, centroid-based, and hierarchical-based clustering algorithms.

Prior to deployment, the detector 440 may be trained on datasets of ground truth labels (e.g., yes/no tags, or struggle/no struggle tags) as well as respective game videos for different aspects of a particular video game (for a game-specific detector) or different aspects of multiple video games (for a game-agnostic detector). The resulting output regarding whether the user should be provided with assistance may therefore be binary as mentioned above, or may be expressed as a matter of degree if desired. Thus, a “yes” output, or degree output over a preset threshold amount, may trigger ensuing logic for providing assistance to the user as set forth in greater detail below. Also note that in addition to or in lieu of game videos, game metadata from the game engine may also be used along with the ground truth labels for training.

The assistance detector model 440 may thus be trained to, during deployment, output an indication 450 (binary or matter of degree) of whether assistance should be provided to the user based on the user's own game actions as indicated in game video and/or other data 445 from the game engine for the user's particular game instance (as fed into the detector 440 as input). The indication 450 may then be used to trigger other parts of the AI architecture 400, including execution of the models 410, 420, and 430 by the system.

The model 410 may be a playstyle pattern recognition model, such as the second model described above in reference to FIG. 2. The playstyle pattern recognition model may therefore be established by a deep learning model, such as a deep convolutional neural network model, or other type of pattern recognition model. As mentioned above, the second model may be trained to recognize different users' playstyles and/or tactics as well as ability level. As such, one or more datasets may be used for training, where the dataset(s)s may include videos, game state data, user inputs to a controller, and/or other items along with respective ground truth labels for those items (for the playstyle, play tactics, and/or ability level involved). Unsupervised learning and other learning techniques may also be used. Thus, during deployment, game video for the user, game state data, user inputs, and other types of data may be fed into the second model as data 405 to then receive an output 415 of playstyle(s), play tactics, and/or ability level for the current user.

The output 415 may then be fed into a cluster recognition model 420 as input, where the model 420 may be established by the third model described above in reference to FIG. 2. The model 420 may thus be used to determine a cluster of previous gameplay instances that also relate to the same particular aspect of the video game, with those previous gameplay instances being instances in which the respective player's action(s) resulted in success in beating, progressing past, or otherwise being successful at the same particular aspect of the game while using a similar playstyle, play tactics, and/or play ability level as those indicated in the input 415.

The model 420 itself may be established by a recurrent neural network, feed-forward neural network, or other neural network configured for pattern recognition. The model 420 may employ various pattern recognition algorithms, including clustering algorithms such as density-based, distribution-based, centroid-based, and hierarchical-based clustering algorithms. As referenced above, the model 420 may be trained for pattern recognition to cluster similar videos of past gameplay together based on one or more common features of the videos, such as game moves/tactics used, game, game type, game level, game world location, player ability level, playstyle, etc. Unsupervised learning may therefore be used, though supervised learning may also be used by employing ground truth labels for the different videos of the training dataset according to the common features mentioned in the last sentence. This allows the model 420 to, during deployment, take the playstyle/play tactics input 415 for the current user along with other current game data such as game name, level, location, etc. to get an output 425 of comparable videos of other players succeeding using similar tactics, playstyle, and/or ability level as the user themselves. Note that the comparable videos may be collected from different users over time and stored in cloud storage as part of a history for later use according to the foregoing.

Still in reference to FIG. 4, note that the output 425 and even other game metadata from the game engine may then be fed into a generative model 430 as input. The model 430 may include, for example, an NLP and/or LLM component for generating a text prompt as set forth above for a particular video output that is desired, with the prompt also referencing/providing the cluster videos from the output 425 as an input to the text-to-video generator. So, for example, the text prompt may request a new, generative video similar to the videos from the input 425 that show success at whatever task the user themselves is trying to accomplish, but with the new video using the user's selected character and the current game state data for the user's own game instance (including, for example, applying any boosts or power-ups that the user is currently using, applying character skins currently being used for the user's character, and applying a current game field of view already selected by the user). To this end, note that training of the NLP/LLM component may be accomplished through unsupervised, deep learning, and/or using datasets of labeled game inputs and resulting prompts/outputs.

The resulting generative video, as generated by the text-to-video generator of the model 430 based on the NLP/LLM prompt that is input to it, may then be output as video 460. This video 460 may be new content not generated from actual gameplay by a real-world user, but instead by the model 430 itself using the videos 425 as a template. The generative video 460 may therefore be much more helpful than, for example, watching the gameplay of an expert gamer beating the same aspect of the game as posted online, since that might not be as helpful to the user themselves owing to the user being unable to match the expert's ability level and skills. So instead of that, the generative video 460 is tailored specifically to the user's own game metrics to demonstrate success in a way that the user is capable of emulating according to the user's own playstyle, tactics, and ability level.

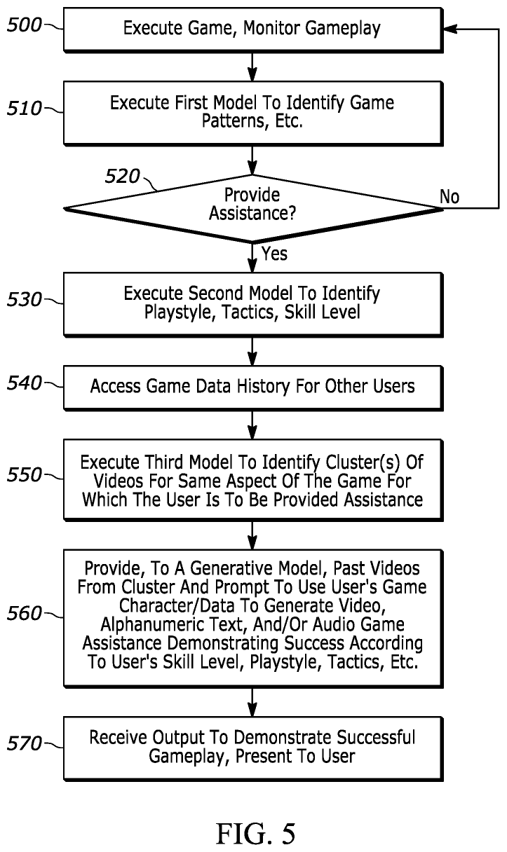

Before describing FIG. 5, also note that the text-to-video component of the model 430 may be trained in various ways, including through unsupervised, deep learning. Additionally or alternatively, the text-to-video component may be trained in supervised fashion using ground truth text prompts and corresponding video outputs. Other generative components included in the model 430, such as a text-to-audio component for generating audio as set forth above, may be trained in supervised fashion using ground truth text prompts and corresponding audio outputs. For generative text, the generative text model may use action recognition to provide a text output describing/narrating what is shown in the generative video itself, and/or may be trained using ground truth videos and corresponding video description outputs.

Turning now to FIG. 5, it shows example overall logic in example flow chart format that may be executed by a device/gaming system consistent with present principles. Beginning at block 500, the device may execute a particular instance of a video game and then monitor gameplay consistent with present principles. The logic may then proceed to block 510 where the device may execute a first model to identify game patterns/struggles of the user, such as executing the assistance detector model 440 described above. The logic may then proceed to decision diamond 520 where, based on output from the assistance detector model 440, the device may determine whether to provide assistance to the user via generative content as described herein.

A negative determination may cause the logic to revert back to block 500 and proceed again therefrom. However, an affirmative determination may instead cause the logic to proceed to block 530. At block 530 the device may execute a second model to identify the particular user's playstyle, play tactics, and skill/ability level. For example, at block 530 the device may execute the playstyle pattern recognition model 410 described above.

From block 530 the logic may then proceed to block 540 where the device may access a game history for one or more other users that have played the same game to, at block 550, execute a third model like the cluster recognition model 420 discussed above. The game data history may be stored in cloud storage at a facility managed by the video game platform's provider or console's manufacturer, for example. The game data history may include segmented raw video from different players playing the same game, along with respective game metadata for each video as provided by the game engine. The metadata may indicate what level or stage of the game is associated with the respective video, what special powers were being used when the respective player played the game as captured in the respective video, and any other game engine data that might be associated with the respective video.

The third model may therefore be executed at block 540 to identify, from the videos in the history, a cluster of videos that relate to the same aspect of the game for which the user is to currently being provided assistance. Once an output from the third model is received, the past videos indicated in the output from the third model may be provided to a generative (fourth) model at block 560. The generative model may be one such as the model 430 described above.

Therefore, at block 560 the past videos of the identified cluster may be used along with a text prompt that is output by the NLP/LLM component for the generative model to subsequently generate one or more generative outputs to present to the user at block 570. Again note that the prompt might be, for example, a prompt to use the user's game character/data to generate video, alphanumeric text, and/or audio game assistance demonstrating successful gameplay according to user's skill level, playstyle, tactics, etc. as represented in the past videos. The generative outputs may therefore include a generative (new) video emulating the relevant user themselves playing the particular aspect of the video game using their same character and game settings, but beating or otherwise succeeding at that aspect of the game rather than struggling to do so as the user is currently experiencing in real life.

Additionally, the NLP/LLM models mentioned above may be used not just to generate a text prompt for a generative video maker to use, but also to prompt the same or a different LLM to provide an additional text output for providing directly to the user. The resulting text output may then be presented at block 570, for example, as an alphanumeric text output like the output 320 instructing the user how to play the particular aspect of the video game using a play style and/or play tactic associated with both the user and past videos from the cluster.

Additionally or alternatively, a text output from the LLM instructing the user how to play the particular aspect of the video game using a play style and/or play tactic associated with both the user and past videos from the cluster may be fed into a text-to-speech engine within the generative AI model as input so that the text input may then be read aloud an audio output to the user at block 570.

But whether presented visually or as audio output, note that these text outputs from the LLM may be the same as or different from the substance of the generative video from the generative video maker of the generative model. E.g., the text outputs may summarize the generative video, but might also narrate the generative video and/or provide additional game tactics and guidance beyond what is shown in the generative video itself.

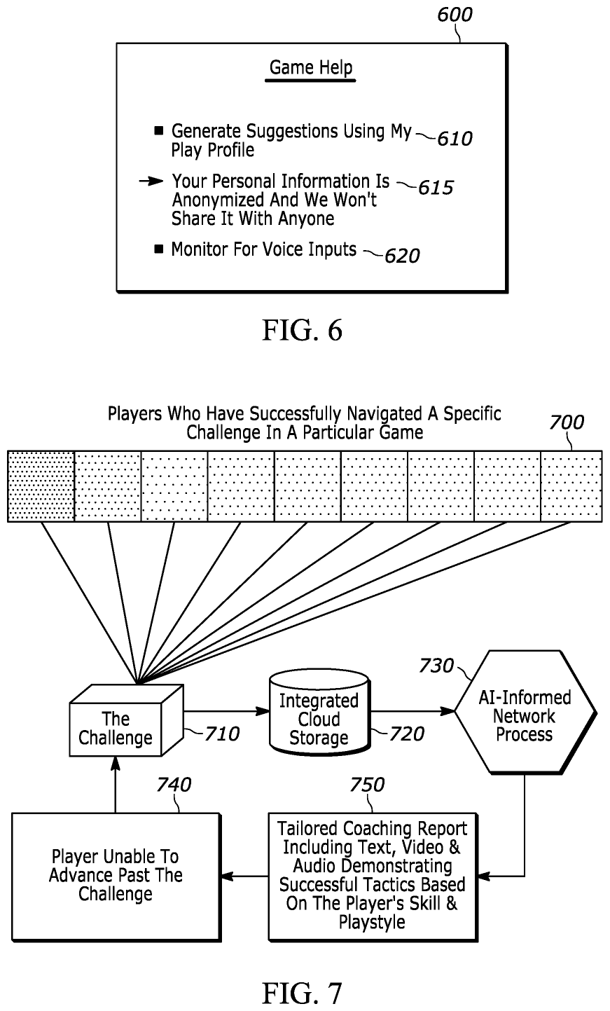

Continuing the detailed description in reference to FIG. 6, it shows an example GUI 600 that may be presented on a display for an end-user (gamer) to configure one or more settings of a device/system to operate consistent with present principles. The GUI 600 may be presented as part of a console settings screen, a game settings screen, etc.

As shown in FIG. 6, the GUI 600 may include a first option 610 that is selectable to set or enable the device to generate assistance/suggestions according to the disclosure above using the user's own play profile (e.g., tactics, playstyle, ability level). For privacy, note 615 indicates that the user's personal information will be anonymized and will not be shared with any other parties. Note that option 610 may therefore be used as an opt-in not just for generative outputs to be provided to that user, but additionally or alternatively as an opt-in for that user's game data to be collected and stored as part of a history for rendering generative outputs to other players to help the experience of other players as well.

As also shown in FIG. 6, the GUI 600 may also include another option 620. The option 620 may be selectable to, if desired, command the device to monitor for voice inputs that might also be useful for helping to identify the user as needing assistance with a particular aspect of the game. It is to therefore be understood consistent with present principles that voice inputs may be parsed to determine if the user provides an audible request for a generative output for coaching, even absent being prompted by the system itself for assistance. Additionally, voice inputs may be parsed to identify frustration and other indications that assistance might be appropriate. Thus, should option 620 be selected, a voice assistant may be executed while the user plays the game so that the voice assistant may identify explicit requests and other natural language that itself may be used to infer that the user should be provided with assistance. These types of voice inputs may in turn serve as a trigger for the system to provide a generative output demonstrating success at the aspect of the game with which the user is struggling.

Now in reference to FIG. 7, a schematic of example network architecture is shown to further illustrate present principles. As shown, a game/video history 700 is shown of past players who have successfully navigated a specific game challenge 710 that a current user is also facing. The history 700 may be stored in cloud storage 720, which itself interfaces with AI-informed network processes such as the models 410, 420, 430, and 440 described above.

Accordingly, once the system identifies at 740 that the user is unable to advance past the relevant challenge, the AI-informed network processes and history 700 as stored in cloud storage 720 may be used to provide a tailored coaching report 750 to the user. The report 750 may include generative text, video, and/or audio demonstrating successful tactics that the current user might use to advance past the specific challenge they are facing based on that user's own skill and playstyle.

Moving on from FIG. 7, it is to be understood that present principles may serve not only single players and single-player games, but also player groups such as when dealing with player versus enemy (PVE) challenges like raid encounters. For instance, present principles may be used to support teams of players with encounters or phases of a particular challenge, utilizing the concepts above.

For example, based on the clustering aspects discussed earlier, teams of players taking on a specific challenge may receive individualized reports based on specific points of failure, from general to specific, based on their individual performance in joint gameplay within the same game instance. As an example of general reports, a first generative output for a first player may instruct the first player to “Go to Zone A and clear the enemies, then damage the boss. Repeat.” A second generative output for a second player may instruct the second player to “Go to Zone B and clear the enemies, then damage the boss. Repeat.” A third generative output for third and fourth players may instruct the third and fourth players to “Go to Zone C and protect the object from enemies.” A fourth generative output for a fifth player may instruct the fifth player to “Carry the item to Zone B, Zone C and then Zone A, and replenish players there. Repeat.” A fifth generative output for a sixth player may instruct the sixth player to “Follow and protect Player 5.” Thus, each player that is jointly playing a single game instance as a team to accomplish a common goal may receive personalized, generative AI outputs tailored to their own playstyle and individual (e.g., assigned) objective within the team.

Regarding specific reports, assume the same example as the paragraph immediately above, but rather than the second player receiving the “general” generative output above, the second player may receive a generative output like “Comparatively, you are not doing enough damage to enemies and the boss. Recommend switching weapons from loadout A to loadout B in your inventory.” And for the fifth player, the fifth player might instead receive a generative output like “Comparatively, you are taking too much damage, resulting in death and mission failure. Recommend switching equipment from armor A to armor B in your inventory.”

It may thus be appreciated based on the foregoing detailed description that AI-generated personalized coaching reports can be provided to game players, leveraging AI to create and even vend personalized reports to players. Aggregate game data of successful players may be used, comparing it to the game data of the requesting player for video game coaching and skill development. Thus, players who get stuck in a game or simply want to improve their skills may request a report from the game platform/console manufacturer detailing the aggregate attributes or actions of successful play. These reports may compare the player's own gameplay data to that of successful players in the form of AI-generated guidance. This may include how to beat a boss or compete more effectively in player-vs-player games. The reports may include text, audio, and video, and may be presented while the player is still immersed in their gameplay experience. Players can process/submit remittance directly from their profile's wallet as maintained by the game platform/console manufacturer in exchange for the coaching report.

Present principles may therefore provide an opportunity to bring joy to players who have difficulty with some video game experiences through the technical improvements discussed herein. Players may thus obtain personalized gameplay analysis and feedback at the moment they desire it, while still remaining engaged in their game and remaining on the game platform/console manufacturer's own network.

While the particular embodiments are herein shown and described in detail, it is to be understood that the subject matter which is encompassed by the present invention is limited only by the claims.

What is claimed is:

1. An apparatus, comprising:
at least one processor system configured to:
determine to provide game assistance to a first player to help the first player play a particular aspect of a video game;
access data related to a cluster of previous gameplay instances that also relate to the particular aspect of the video game;
based on the determination, execute a generative model to provide an output to the player related to playing the particular aspect of the video game, the output generated based on the data related to the cluster of previous gameplay instances that also relate to the particular aspect of the video game.

2. The apparatus of claim 1, wherein the data comprises past videos of previous gameplay instances that also relate to the particular aspect of the video game, and wherein the output comprises a first video that is generated by the generative model based on the past videos of previous gameplay instances, the first video showing the first player how to play the particular aspect of the video game using a play style and/or play tactic associated with both the first player and the past videos.

3. The apparatus of claim 1, wherein the data comprises past videos of previous gameplay instances that also relate to the particular aspect of the video game, and wherein the output comprises audio output instructing the first player how to play the particular aspect of the video game using a play style and/or play tactic associated with both the first player and the past videos.

4. The apparatus of claim 1, wherein the data comprises past videos of previous gameplay instances that also relate to the particular aspect of the video game, and wherein the output comprises alphanumeric text output instructing the first player how to play the particular aspect of the video game using a play style and/or play tactic associated with both the first player and the past videos.

5. The apparatus of claim 1, wherein the at least one processor system is configured to:
make the determination using a first pattern recognition model.

6. The apparatus of claim 5, wherein the at least one processor system is configured to:
associate the previous gameplay instances with each other using a second pattern recognition model.

7. The apparatus of claim 1, wherein the output is tailored to a gameplay ability level identified for the first player.

8. The apparatus of claim 1, wherein the at least one processor system is configured to:
based on the determination, present a prompt to the first player that the output is available.

9. The apparatus of claim 1, wherein the output indicates a same sequence of game moves that have been identified as being performed by the first player while playing the particular aspect of the video game.

10. The apparatus of claim 1, wherein the at least one processor system is configured to:
provide the output responsive to a request from the first player for assistance.

11. The apparatus of claim 10, wherein the request from the first player for assistance comprises an audible request.

12. The apparatus of claim 1, wherein the particular aspect of the video game relates to a boss battle.

13. The apparatus of claim 1, wherein the particular aspect of the video game relates to navigating a particular area of a virtual world of the video game.

14. A method, comprising:
determining to provide game assistance to a first player to help the first player play a particular aspect of a video game;
accessing data related to previous gameplay instances that also relate to the particular aspect of the video game;
based on the determination, executing a generative model to provide an output to the player related to playing the particular aspect of the video game, the output generated based on the data related to previous gameplay instances that also relate to the particular aspect of the video game.

15. The method of claim 14, comprising:
identifying the previous gameplay instances based on the previous gameplay instances being associated with other players of a similar skill level as the first player.

16. The method of claim 14, comprising:
identifying the previous gameplay instances based on the previous gameplay instances using a same game move that the first player has been identified as using to play the particular aspect of the video game.

17. The method of claim 14, comprising:
identifying the previous gameplay instances based on the previous gameplay instances using a same playstyle as the first player has been identified as using to play the particular aspect of the video game.

18. The method of claim 14, comprising:
identifying the previous gameplay instances based on each of:
the previous gameplay instances being associated with other players of a similar skill level as the first player;
the previous gameplay instances using a same game move that the first player has been identified as using to play the particular aspect of the video game; and
the previous gameplay instances using a same playstyle as the first player has been identified as using to play the particular aspect of the video game.

19. An apparatus, comprising:
at least one computer medium that is not a transitory signal and that comprises instructions executable by at least one processor system to:
determine to provide game assistance to a first player to help the first player play a particular aspect of a video game;
based on the determination, execute a model to provide an output to the player related to playing the particular aspect of the video game, the output generated based on video game data for previous gameplay instances that relate to success at the particular aspect of the video game.

20. The apparatus of claim 19, wherein the model comprises one or more of: a pattern recognition model, a generative model.
